(19) United States
(12) Patent Application Publication
(10) Pub. No.: US 2010/0306743 A1
(43) Pub. Date: Dec. 2, 2010

(54) SYSTEM AND METHOD FOR VERIFYING CODE SEQUENCE EXECUTION

(75) Inventor: Mark Underseth, Carlsbad, CA (US)

Correspondence Address: KNOBBE MARTENS OLSON & BEAR LLP, 2040 MAIN STREET, FOURTEENTH FLOOR, IRVINE, CA, 92614, US

(73) Assignee: S2 Technologies, Inc, Encinitas, CA (US)

(21) Appl. No.: 12/790,068

(22) Filed: May 28, 2010

Related U.S. Application Data
(60) Provisional application No. 61/182,634, filed on May 29, 2009.

(51) Int. Cl. G06F 9/44

(52) U.S. Cl. 717/124

(57) ABSTRACT

A system and method for verifying code sequence execution are disclosed herein. In one embodiment, the method comprises receiving, via an application programming interface, an expectation set comprising information regarding a plurality of test points expected to be hit, receiving test point data comprising information regarding which test points which have been hit, and determining whether the hit test points comprise the test points expected to be hit.

### CROSS-REFERENCE TO RELATED APPLICATIONS

This application claims priority under 35 U.S.C. §119(e) to U.S. Provisional App. No. 61/182,634, filed May 29, 2009, which is herein incorporated by reference in its entirety, including, but not limited to, all Appendices.

This application is related to U.S. patent application Ser. No. 12/435,998, filed May 5, 2009 which is a continuation of U.S. patent application Ser. No. 11/061,283, filed Feb. 18, 2005, which is a continuation-in-part of the following commonly owned patent applications: U.S. patent application Ser. No. 10/105,061, titled “System and method for formatting data for transmission between an embedded computer and a host computer having different machine characteristics,” filed Mar. 22, 2002, now U.S. Pat. No. 7,111,302; U.S. patent application Ser. No. 10/104,989, titled “System and method for building a database defining a plurality of communication interfaces,” filed Mar. 22, 2002, now U.S. Pat. No. 7,359,911; U.S. patent application Ser. No. 10/104,985, titled “System and method for providing an interface for scripting programs to communicate with embedded systems,” filed Mar. 22, 2002, now U.S. Pat. No. 7,062,772; U.S. patent application Ser. No. 10/105,062, titled “System and method for providing an interface for COM-compliant applications to communicate with embedded systems,” filed Mar. 22, 2002; and U.S. patent application Ser. No. 10/105,069, titled “System and method for generating data sets for testing embedded systems,” filed Mar. 22, 2002, now U.S. Pat. No. 7,237,230.

Each of the foregoing priority applications of which application Ser. No. 11/061,283 is a continuation-in-part claims the benefit of the following applications: U.S. Provisional Application No. 60/278,212, filed Mar. 23, 2001, titled “System for debugging and tracing the performance of software targeted for embedded systems” and U.S. Provisional Application No. 60/299,555, filed Jun. 19, 2001, titled “Messaging system and process”, and U.S. Provisional Application No. 60/363,436, filed Mar. 11, 2002, titled “Development and testing system and method.”

All of the above-referenced applications are herein incorporated by reference in their entirety.

### BACKGROUND

1. Field

The field of the invention relates to software testing.

2. Description of Related Technology

Once a software application has been written as source code, a developer can test the application to ensure proper code sequence execution under various conditions. A typical example of this problem involves verification of correct state transition within an application. Applications can encounter an event and thus transition from a first state to a second state. Another example of verifying proper code sequence execution involves determining if a block of code is executed under specific circumstances. For example, a sequence of code may be expected to be executed only if a conditional expression is met.

One problem with existing source code instrumentation techniques is that verification is performed manually, such as by a visual audit by a domain expert, and cannot be automatically executed. Embodiments disclosed herein solve this problem and provide automated verification of proper code sequence execution.

### SUMMARY

The system, method, and devices of the invention each have several aspects, no single one of which is solely responsible for its desirable attributes. Without limiting the scope of this invention, its more prominent features will now be discussed briefly. After considering this discussion, and particularly after reading the section entitled “Detailed Description” one will understand how the features of this invention provide advantages over other methods of verifying proper code sequence execution.

One aspect is a method comprising receiving, via an application programming interface, an expectation set comprising information regarding a plurality of test points expected to be hit, receiving test point data comprising information regarding which test points which have been hit, and determining whether the hit test points comprise the test points expected to be hit.

Another aspect is a system comprising a processor configured to implement an application programming interface for receiving an expectation set comprising information regarding a plurality of test points expected to be hit, receive test point data comprising information regarding which test points which have been hit, and determine whether the hit test points comprise the test points expected to be hit.

Another aspect is a system comprising means for receiving, via an application programming interface, an expectation set comprising information regarding a plurality of test points expected to be hit, means for receiving test point data comprising information regarding which test points which have been hit, and means for determining whether the hit test points comprise the test points expected to be hit.

Another aspect is a computer-readable medium having processor-executable instructions encoded thereon which, when executed by a processor, cause a computer to perform a method, the method comprising receiving, via an application programming interface, an expectation set comprising information regarding a plurality of test points expected to be hit, receiving test point data comprising information regarding which test points which have been hit, and determining whether the hit test points comprise the test points expected to be hit.

### BRIEF DESCRIPTION OF THE DRAWINGS

FIG. 1 is flowchart illustrating a method of testing and modifying source code.

FIG. 2 is a flowchart illustrating a method of generating an indication of whether or not an expectation set is satisfied.

FIG. 3 is a functional block diagram of a computer system.

### DETAILED DESCRIPTION

The following detailed description is directed to certain specific aspects of the development. However, the development can be embodied in a multitude of different ways, for example, as defined and covered by any presented claims. It should be apparent that the aspects herein may be embodied in a wide variety of forms and that any specific structure, function, or both being disclosed herein is merely representative. Based on the teachings herein one skilled in the art should appreciate that an aspect disclosed herein may be implemented independently of any other aspects and that two or more of these aspects may be combined in various ways. For example, an apparatus may be implemented or a method may be practiced using any number of the aspects set forth herein. In addition, such an apparatus may be implemented or such a method may be practiced using other structure, functionality, or structure and functionality in addition to or other than one or more of the aspects set forth herein. Similarly, methods disclosed herein may performed by one or more computer processors configured to execute instructions retrieved from a computer-readable storage medium. A computer-readable storage medium stores information, such as data or instructions, for some interval of time, such that the information can be read by a computer during that interval of time. Examples of computer-readable storage media are memory, such as random access memory (RAM), and storage, such as hard drives, optical discs, flash memory, floppy disks, magnetic tape, paper tape, punch cards, and Zip drives.

In order to test a piece of source code, denoted the “source under test,” a programmer or developer can, prior to execution of the source under test, add a function call at certain test points of the source under test that broadcasts a message. These test points can be added automatically or manually. The programmer or developer can define the message to be broadcast, or there may be a default message programmed into the predefined function. The message may be broadcast from the process running the code to, e.g., a memory, another process within the same processor, or a process running in a host processor.

The programmer or developer can further define an expectation set that specifies which messages are expected to be received by the API upon execution of the source code. Software, such as a graphical user interfere (GUI) may be utilized in assisting the programmer or developer in inserting the test points and/or defining the expectation set. An exemplary GUI is described in U.S. Provisional App. No. 61/182,634, herein incorporated by reference in its entirety.

The expectation set can be specified such that when the expectation set is satisfied (e.g., when those messages which are expected to be received are, in fact, received), the source under test is performing as desired. The expectation set can be specified such that when the expectation set is not satisfied, the source under test requires modification in order to perform as desired.

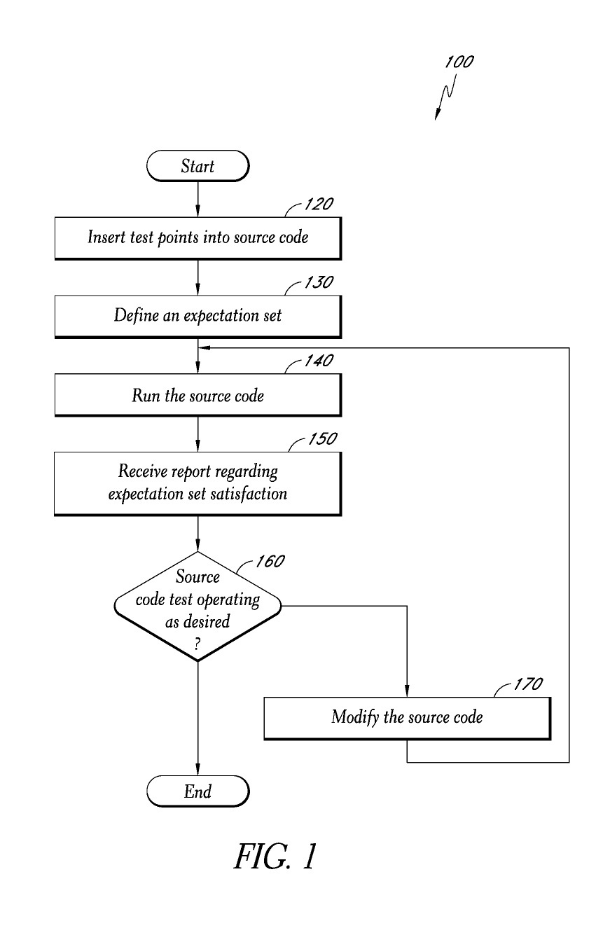

FIG. 1 is a flowchart illustrating a method 100 of testing and developing source code. The method 100 begins, in block 120 with the insertion of test points into source code being tested and developed. The test points can be inserted manually or automatically. In one embodiment, test points are inserted by adding test point function calls into the code via a code editor displayed via a graphical user interface.

A test point function generally serves to generate an indication that the test point function has been called. The test point function calls are inserted at test points, and when a test point function at a particular test point is called, this is referred to as the particular test point being “hit.” In one embodiment, the test point function takes a label as an input and, when the function is called in a first thread or process, outputs the label to a log file or to a second thread or process. In one embodiment, the label is a pointer to a null-terminated string. In another embodiment, the test point function takes a label, data, and size as input and outputs the label, data and size when the function is called. In one embodiment, the data is a pointer to a byte sequence and the size is the size of the data in bytes. In another embodiment, the test point function takes a label and a message as an input and outputs the label and the message when the function is called. In one embodiment, the message is a pointer to a null-terminated string. Table 1 lists a number of test point functions which can be included in an API, such as the API described in U.S. application Ser. No. 12/435,998, herein incorporated by reference in its entirety.

TABLE 1

| | |
|---|---|
| srTEST_POINT | label is a pointer to a null-terminated |
| (label) | string |
| srTEST_POINT_DATA | label is a pointer to a null-terminated |
| (label, data, size) | string |
| | data is a pointer to a byte sequence |
| | size is the size of the data in bytes |
| srTEST_POINT_STR | label is a pointer to a null-terminated |
| (label, message) | string |
| | message is a pointer to a null-terminate |
| | d string |
| | When used in the context of a c++ |
| | compilation unit, this macro also |
| | supports the streaming operator to |
| | append to the message string (see |
| | example below) |
| srTEST_POINT_STR[1 . . . 9] | label is a pointer to a null-terminated |
| (label, message, . . .) | string |
| | message is a pointer to a null-terminated |
| | format string |
| | . . . variable list (up to 9) matching the |
| | format string |

In one embodiment, inserting test points includes inserting a header file in addition to test point function calls. An exemplary header file, denoted srtest.h, is included in Appendix C of U.S. Provisional App. No. 61/182,634, incorporated by reference herein. In one embodiment, the test point function calls are functional only when a particular Boolean is set to TRUE. In one embodiment, definition of this Boolean can be performed by the header file.

An exemplary use of test points as inserted into source code according to one embodiment is illustrated in the code portion below:

#include <srtest.h>
...
/* a test point with no payload */
srTEST_POINT(“first test point”);
/* a test point with binary payload */
srTEST_POINT_DATA(“second test point”, myData,
sizeofMyData);
/* a test point with simple string payload */
srTEST_POINT_STR(“third test point”, “payload with simple
string”);
/* a test point with formatted string payload */
srTEST_POINT_STR1(“third test point”, “payload with format
string %d”, myVar);
#ifdef _{——}cplusplus
srTEST_POINT_STR(“c++ test point”, ““) << “stream input
supported under c++”;
#endif

Once test points have been inserted, the method 100 moves to block 130 where an expectation set is defined. The expectation set is generally a set of criterion to be satisfied which reference the test points. For example, the expectation set can include a list of test points expected to be reached when the code is invoked. The expectation set can also include a list of test point expected to not be reached when the code is invoked.

In one embodiment, the expectation set includes a list of test points, wherein each test point is associated with a label to be output by the test point function to an expectation checking thread or process, a number of times the label is expected to be output by the test point function, and/or data which is expected to be output by the test point function. The expectation checking thread or process can be run in a separate thread, process, or processor from that of the source code into which the test points are inserted. Thus, the expectation set can be separately developed from the source under test. For example, in one embodiment, the expectation set is defined on a separate processor, stored in a memory or portable computer-readable medium, and/or received over a communications interface. One or more expectation sets can be defined for various use cases using a scripting language, a COM-compliant application interface, or a GUI such as those described in U.S. Provisional App. No. 61/182,634, herein incorporated by reference in its entirety.

The expectation set can also include processing properties used by the expectation checking thread or process in determining whether the expectation set is satisfied. When the expectation set is defined, a Boolean variable can be set defining whether the test points are expected to be hit in a defined order or in any order. A second Boolean variable can be set defining whether the test points are expected to be hit exactly as defined in the list, or if duplication is acceptable.

In one embodiment, defining the expectation set includes registering the expectation set with the API, such as the API described in U.S. Provisional App. No. 61/182,634, herein incorporated by reference in its entirety. In one embodiment, the expectation set includes expected data associated with one or more of the test points indicative of data expected to be output when the test points are hit. In one embodiment, the expectation set includes timing information indicative of when one or more test points are expected to be hit.

The expectation set can include both simple and complex logical functions of test point hits. For example, in one embodiment the expectation set is satisfied only if all of a defined set of expected test points are hit and none of a defined set of unexpected test points are hit. In another embodiment, the expectation set is satisfied only if a first test point is hit within a predefined time of a second test point being hit. In one embodiment, the expectation set is satisfied only if a particular test point is hit at least N times, where N is a predefined integer. In another embodiment, the expectation set is satisfied only if a particular test point is hit exactly N times, where N is a predefined integer.

In one embodiment, the expectation set is satisfied only if a first test point, a second test point, and a third test point are hit in a specific order. In another embodiment, the expectation set is satisfied only if a first test point, a second test point, and a third test point are hit regardless of order.

The expectation set can include complex logical functions linked with AND or OR statements. For example, in one embodiment, the expectation set is satisfied only if a first test point is hit before a second test point OR the second test point is hit before a third test point AND a fourth test point is hit at least three times. It will be appreciated that the above examples are non-limiting and those of ordinary skill in the art could define other logical functions of test point hits.

Although block 120 and block 130 are illustrated and described sequentially, it is to be appreciated that the steps of the method 100 described therein could be performed in reverse order, or simultaneously. For example, a programmer can simultaneous develop and define the expectation set while inserting test points.

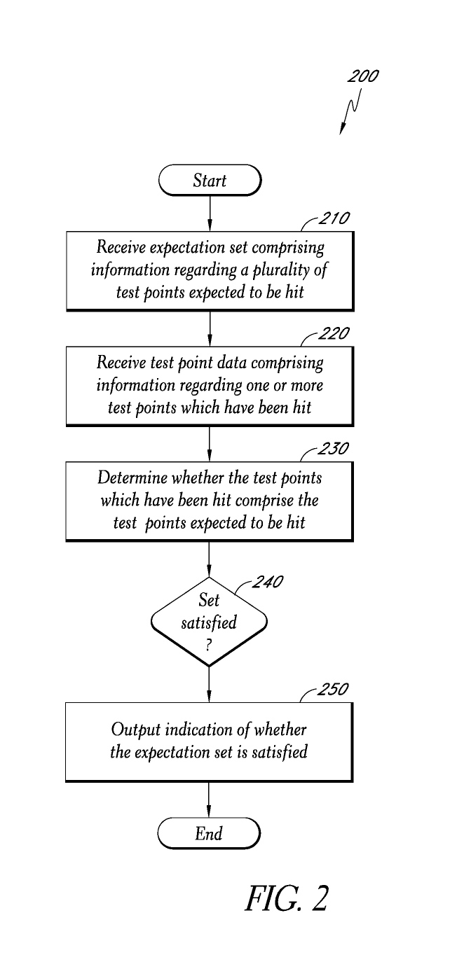

When the test point have been inserted and the expectation set is defined, the method 100 continues to block 140 in which the source code is run. As the source code is run, various test points are hit, resulting in messages being broadcast which are interpreted and automatically compared to the expectation set, as described more with respect to FIG. 2. The source code being run can include multiple thread and/or multiple processes. The source can being run can include source code on two physically separate devices, such as a host device and a remote device. Embodiments of host machine/remote machine architecture are described in U.S. Provisional App. No. 61/182,634, herein incorporated by reference in its entirety.

The steps associated with blocks 130 and 140 in which the expectation set is defined and registered with the API and the source under test is run can be performed, in one embodiment, using the following code:

#include <srtest.h>
void tf_testpoint_wait(void)
{

/* specify expected set */
srTestPointExpect_t expected[ ]= {

{“START”},
{“ACTIVE”},
{“IDLE”},
{“END”},
{0}};

/* specify unexpected set */
srTestPointUnexpect_t unexpected[ ]= {

{“INVALID”},
{0}};

/* register the expectation set with the STRIDE */
srWORD handle;
srTestPointSetup(expected, unexpected,

srTEST_POINT_EXPECT_UNORDERED,
srTEST_CASE_DEFAULT, &handle);

/* start your asynchronous operation */
...
/* wait for expectation set to be satisfied or a timeout

to occur */

srTestPointWait (handle, 1000);

}
#ifdef _SCL
#pragma scl_test_flist(“testfunc”, tf_testpoint_wait)
#endif

The above code portion includes specification of an “expected” data structure of the srTestPointExpect_t type and an “unexpected” data structure of the srTestPointUnexpect_t type. Each data structure is specified as a list of test point labels identifying one or more test points. The data structure can be further generated to associate with each test point, in addition to a label, a number of times the test point is expected to be hit, or data expected to be returned when the test point is hit, as shown in the exemplary code below to typedef the srTestPointExpect_t data structure type.

typedef struct
{

| /* the label value is considered the test point's identity */ | |
|---|---|
| const srCHAR * | label; |

/* optional, count specifies the number of times the test point

is expected to be hit */

| | |
|---|---|
| srDWORD | count; |

/* optional, predicate function to use for payload validation

against user data */

| srTestPointPredicate_t | predicate; |
|---|---|
| /* optional, user data to validate the payload against */ | |
| void * | user; |

} srTestPointExpect_t;

For example, if the expected test point hit pattern includes a START test point, followed by 3 PROGRESS test points, and an END test point, the following code could be used:

srTestPointExpect_t expected[ ]= {

{“START”},
{“PROGRESS”,3},
{“END”},
{0}};

In another example, if the expected test point hit pattern includes a START test point, followed by a PROGRESS test point returning the string “abc”, the following code could be used:

srTestPointExpect_t expected[ ]= {

{“START”},
{“PROGRESS”,1,stTestPointStrCmp,”abc”},
{“END”},
{0}};

The code portion above, illustrates four variables which can be associated with each test point within the data structure. The PROGRESS test point is associated with a label (“PROGRESS”), a count (1), a predicate function (stTestPointStrCmp), and expected data which the predicate function uses to compare with the data returned by the test point (“abc”). In one embodiment, if the count, the predicate function, or the expected data are omitted, they are set to a default value.

The code above also includes a call to the function srTestPointSetup which registers the expectation set with the API. The srTestPointSetup function is passed a pointer to an expected array, a pointer to an unexpected array, a bitmask which specifies whether the expected test points occur in order and/or if duplicates are acceptable, a handle to a test case, and a handle that represents the registered expectation set. The srTestPointSetup function returns a Boolean indicative of whether the expectation set was satisfied or unsatisfied.

The following code can be used to invoke srTestPointSetup, wherein the parameters passed to and returned by the function are as described in Table 2.

srBOOL srTestPointSetup(srTestPointExpect_t* ptExpected,

srTestPointUnexpect_t* ptUnexpected,
srBYTE yMode,
srTestCaseHandle_t tTestCase,
srWORD* pwHandle);

Table 2 describes the parameters of srTestPointSetup.

TABLE 2

| Parameters | Type | Description |
|---|---|---|
| ptExpected | Input | Pointer to an expected array. |
| ptUnexpected | Input | Pointer to an unexpected array. This is optional |
| | | and could be set srNULL. |
| yMode | Input | Bitmask that specifies whether the expectated |
| | | test points occur in order and/or strict. |
| | | Possible values are: |
| | | srTEST_POINT_EXPECT_ORDERED - the |
| | | test points are expected to be hit exactly in |
| | | the defined order |
| | | srTEST_POINT_EXPECT_UNORDERED - |
| | | the test points could to be hit in any order |
| | | srTEST_POINT_EXPECT_STRICT - the test |
| | | points are expected to be hit exactly as |
| | | specified |
| | | srTEST_POINT_EXPECT_NONSTRICT - |
| | | other test points from the universe could to be |
| | | hit in between |
| tTestCase | Input | Handle to a test case. |
| | | srTEST_CASE_DEFAULT can be used for |
| | | the default test case. |
| pwHandle | Output | Handle that represents the registered |
| | | expectation set |

| Return Value | Description |
|---|---|
| srBOOL | srTRUE on success, srFALSE otherwise. |

The code above also includes a call to the function srTestPointWait which is used to wait for the expectation to be satisfied. The srTestPointWait function is passed a handle of a registered expectation set and a timeout value in milliseconds. The srTestPointWait function returns a Boolean indicative of whether the expectation set was satisfied or unsatisfied (within the time allotted).

The following code can be used to invoke srTestPointWait, wherein the parameters passed to and returned by the function are as described in Table 3.

srBOOL srTestPointWait(srWORD wHandle,

srDWORD dwTimeout);

TABLE 3

| Parameters | Type | Description |
|---|---|---|
| wHandle | Input | Handle to a registered expectation set. |
| dwTimeout | Input | Timeout value in milliseconds; 0 means just |
| | | check without waiting. |

| Return Value | Description |
|---|---|
| srBOOL | srTRUE on success, srFALSE otherwise. |

A function, denoted srTestPointCheck, which is not included in the code above, can be used to check if the expectation set is satisfied post routine completion. This is useful for verifying a set of expectation events that should have already transpired. The srTestPointCheck is passed a handle of the registered expectation set and returns a Boolean indicative of whether the expectation set was satisfied or unsatisfied.

The following code can be used to invoke srTestPointCheck, wherein the parameters passed to and returned by the function are as described in Table 3, with the exception that dwTimeout is unused.

srBOOL srTestPointCheck(srWORD wHandle);

The method 100 moves to block 150 where a report regarding expectation set satisfaction is received. The report can contain an indication of whether or not the expectation set was satisfied. The report can also contain information regarding the source file names and line numbers where test points were hit (whether expected or unexpected), timing information specifying when each test point was hit (whether expected or unexpected), and whether or not specified expectations were met (e.g., logical functions evaluated as TRUE or FALSE). The report can be stored in a memory or displayed to a user.

Next, in block 160, it is determined whether or not the source code is operating as desired. In one embodiment, it is determined that the source code is operating as desired if the expectation set is satisfied. In another embodiment, it is determined whether or not the source code is operating as desired based on information contained in the report. If the source code is operating as desired, the method 100 ends. If the source code is not operating as desired, the method 100 continues to block 170 where the source code is modified. The source code can be modified, for example, by using a code editor displayed via a graphical user interface.

The method 100 moves from block 170 returning to block 140 where the modified source code is run. The method can repeat blocks 140, 150, 160, and 170 until the source code is operating as desired.

As mentioned above with respect to FIG. 1, when source code is run, various test points are hit, resulting in messages being broadcast which are interpreted and automatically compared to the expectation set. Further, in the method 100 of FIG. 1, a report is received indicating, at least, whether or not the expectation set was satisfied.

FIG. 2 is a flowchart illustrating a method 200 of generating an indication of whether or not an expectation set is satisfied. The method 200 begins in block 210 where an expectation set is received comprising information regarding a plurality of test points expected to be hit. In one embodiment, the expectation set is received via an application programming interface (API). In one embodiment, the expectation set includes information regarding a plurality of test points expected to be hit. In one embodiment, the expectation set includes information regarding a plurality of test points which are not expected to be hit. In one embodiment, one or more test points are respectively associated with one or more labels. In one embodiment, the expectation set includes information regarding an expected order in which the test points are expected to be hit. In one embodiment, the expectation set includes information regarding one or more expected times the test points are expected to be hit. In one embodiment, the expectation set includes expected test point data associated with at least one test point.

The method 200 continues to block 220 where test point data is received comprising information regarding one or more test points which have been hit. In one embodiment, as described above, test point function calls are inserted into source code and the test point functions, when called, broadcast a message indicating that the test point function has been called. When a test point function, inserted at particular test point, has been called, this is referred to as the particular test point having been hit. In one embodiment, receiving test point data includes receiving messages from test point functions which have been called.

As mentioned above, the test point data includes information regarding which test points have been hit. In one embodiment, the test point data includes the order in which the test points have been hit. In one embodiment, the test point data includes information regarding when the test points have been hit. In one embodiment, the test point data includes data returned by the test point function calls, such as values of particular variables. In one embodiment, the test point data can include source file names and lines numbers where each test point was hit.

Next, in block 230, it is determined whether the test points which have been hit comprise the test points expected to be hit. For example, it is determined whether the test point which were expected to be hit, have been hit.

The method 200 continues to block 240 where it is determined whether the expectation set is satisfied. The determination of block 240 can be based on the determination of block 230 of whether the test points which have been hit comprise the test points expected to be hit. The determination of block 240 can also be based on other determinations.

As just mentioned, in one embodiment, determining whether the expectation set is satisfied is based on a determination of whether the test points which have been hit comprise the test points expected to be hit. In one embodiment, determining whether the expectation set is satisfied is based on a determination of whether the test points have been hit in an expected order. In one embodiment, determining whether the expectation set is satisfied is based on a determination of whether the test points which have been hit comprise (or do not comprise) the test point not expected to be hit. In one embodiment, determining whether the expectation set is satisfied is based on a determination of whether data returned by the test point function calls matches expected data.

Based on the determination in block 240, the method 200 continues to block 250 where an indication of whether the expectation set is satisfied is output. In one embodiment, the indication is part of an output report, which can be stored in a memory or displayed to a user. The report can contain an indication of whether or not the expectation set was satisfied. The report can also contain information regarding the source file names and line numbers where test points were hit (whether expected or unexpected), timing information specifying when each test point was hit (whether expected or unexpected), and whether or not specified expectations were met.

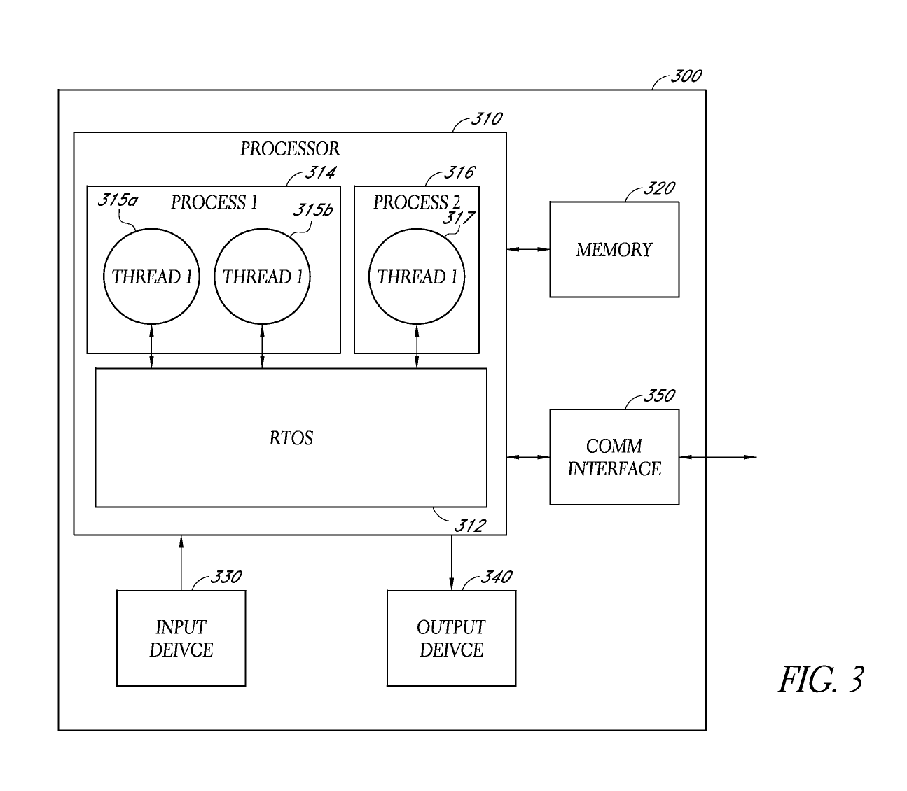

FIG. 3 is a functional block diagram of a computer system 300 that can, for example, perform the method 200 of FIG. 2 or be used to perform the method 100 of FIG. 1. The computer system 300 includes a processor 310 in data communication with a memory 320, an input device 330, and an output device 340. The processor is further in data communication with a communication interface 350. The computer system 300 and components thereof are powered by a battery and/or an external power source. In some embodiments, the battery, or a portion thereof, is rechargeable by an external power source via a power interface. Although described separately, it is to be appreciated that functional blocks described with respect to the computer system 300 need not be separate structural elements. For example, the processor 310 and memory 320 may be embodied in a single chip. Similarly, the processor 310 or communication interface 350 may be embodied in a single chip. Additionally, the input device 330 and output device 340 may be a single structure, such as a touch screen display.

The processor 310 can be a general purpose processor, a digital signal processor (DSP), an application specific integrated circuit (ASIC), a field programmable gate array (FPGA) or other programmable logic device, discrete gate or transistor logic, discrete hardware components, or any suitable combination thereof designed to perform the functions described herein. A processor may also be implemented as a combination of computing devices, e.g., a combination of a DSP and a microprocessor, a plurality of microprocessors, one or more microprocessors in conjunction with a DSP core, or any other such configuration.

The processor 310 can be coupled, via one or more buses, to read information from or write information to memory 320. The processor may additionally, or in the alternative, contain memory, such as processor registers. The memory 320 can include processor cache, including a multi-level hierarchical cache in which different levels have different capacities and access speeds. The memory 320 can also include random access memory (RAM), other volatile storage devices, or non-volatile storage devices. The storage can include hard drives, optical discs, such as compact discs (CDs) or digital video discs (DVDs), flash memory, floppy discs, magnetic tape, and Zip drives.

The processor 310 is also coupled to an input device 330 and an output device 340 for, respectively, receiving input from and providing output to, a user of the computer system 300. Suitable input devices include, but are not limited to, a keyboard, buttons, keys, switches, a pointing device, a mouse, a joystick, a remote control, an infrared detector, a video camera (possibly coupled with video processing software to, e.g., detect hand gestures or facial gestures), a motion detector, a microphone (possibly coupled to audio processing software to, e.g., detect voice commands), or an accelerometer. Suitable output devices include, but are not limited to, visual output devices, including displays and printers, audio output devices, including speakers, headphones, earphones, and alarms, and haptic output devices, including force-feedback game controllers and vibrating devices.

The processor 310 is further coupled to a communication interface 350. The communication interface 350 allows the computer system 300 to communication with other systems and devices. In some embodiments, the computer system 300 is a mobile telephone, a personal data assistant (PDAs), a camera, a GPS receiver/navigator, an MP3 player, a camcorder, a game console, a wrist watch, a clock, a television, or a computer (e.g., a hand-held computer, a laptop computer, or a desktop computer).

The processor 310 can be capable of running multiple processes, including a runtime operating system 312, a first process 314, and a second process 316. Each of the processes may have one or more threads 315a, 315b, 317 running therein. The processes and threads can communicate with each other by sending messages. In one embodiment, these messages, or the data encoded therein, can be sent via the communication interface to another device, or a process or thread running in the processor of another device.

Accordingly, in one embodiment, as mentioned above, test points can be inserted in source code running in two processes 314, 316 on a single processor 310. This could be particularly useful in source code developed for to Linux/Window-based operating systems. For example, if a developer had two applications running with at least one dependent on the other and wanted to verify that each behaved correctly, the developer can validate the sequencing (along with data) of both applications with one expectation set.

As mentioned above, the expectation set can be stored in a memory of a host machine while the test points are inserted in source code run on a processor of remote device, physically separate from the host machine. Embodiments of host machine/remote machine architecture are described in U.S. Provisional App. No. 61/182,634, herein incorporated by reference in its entirety.

While the specification describes particular examples of the present invention, those of ordinary skill can devise variations of the present invention without departing from the inventive concept.

Those skilled in the art will understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Those skilled in the art will further appreciate that the various illustrative logical blocks, modules, circuits, methods and algorithms described in connection with the examples disclosed herein may be implemented as electronic hardware, computer software, or combinations of both. To clearly illustrate this interchangeability of hardware and software, various illustrative components, blocks, modules, circuits, methods and algorithms have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present invention.

The various illustrative logical blocks, modules, and circuits described in connection with the examples disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The methods or algorithms described in connection with the examples disclosed herein may be embodied directly in hardware, in a software module executed by a processor, or in a combination of the two. A software module may reside in RAM memory, flash memory, ROM memory, EPROM memory, EEPROM memory, registers, hard disk, a removable disk, a CD-ROM, or any other form of storage medium known in the art. A storage medium may be coupled to the processor such that the processor can read information from, and write information to, the storage medium. In the alternative, the storage medium may be integral to the processor. The processor and the storage medium may reside in an ASIC.

In one or more exemplary embodiments, the functions described may be implemented in hardware, software, firmware, or any combination thereof. If implemented in software, the functions may be stored on or transmitted over as one or more instructions or code on a computer-readable medium. Computer-readable media includes both computer storage media and communication media including any medium that facilitates transfer of a computer program from one place to another. A storage media may be any available media that can be accessed by a general purpose or special purpose computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code means in the form of instructions or data structures and that can be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, includes compact disc (CD), laser disc, optical disc, digital versatile disc (DVD), floppy disk and blu-ray disc where disks usually reproduce data magnetically, while discs reproduce data optically with lasers. Combinations of the above should also be included within the scope of computer-readable media.

The previous description of the disclosed examples is provided to enable any person skilled in the art to make or use the present invention. Various modifications to these examples will be readily apparent to those skilled in the art, and the generic principles defined herein may be applied to other examples without departing from the spirit or scope of the invention. Thus, the present invention is not intended to be limited to the examples shown herein but is to be accorded the widest scope consistent with the principles and novel features disclosed herein.

What is claimed is:

1. A method comprising:
receiving, via an application programming interface, an expectation set comprising information regarding a plurality of test points expected to be hit;
receiving test point data comprising information regarding which test points which have been hit; and
determining whether the hit test points comprise the test points expected to be hit.

2. The method of claim 1, wherein the expectation set comprises information regarding a plurality of test points not expected to be hit, further comprising determining whether the hit test points do not comprise the test points not expected to be hit.

3. The method of claim 1, wherein the expectation set comprises information regarding expected data associated with one or more test points, wherein the test point data comprises returned data associated with one or more test points, further comprising determining whether the returned data matches the expected data.

4. The method of claim 1, wherein the expectation set comprises information regarding one or more expected times the plurality of test points are expected to be hit and wherein the test point information comprises information regarding when the test points have been hit, further comprising determining whether the test point have been hit within the expected times.

5. The method of claim 1, wherein the expectation set comprises information regarding an expected order in which the plurality of test point are expected to be hit and wherein the test point data comprises information regarding the order in which the test points have been hit, further comprising determining whether the order in which the test points have been hit is the same as the expected order.

6. The method of claim 1, wherein the expectation set comprises information regarding a expected number of times which a particular test point is expected to be hit, wherein the test point data comprises information regarding a number of times the particular test point is hit, further comprising determining whether the number of times is greater than or equal to the expected number of times.

7. The method of claim 1, wherein the expectation set comprises information regarding a expected number of times which a particular test point is expected to be hit, wherein the test point data comprises information regarding a number of times the particular test point is hit, further comprising determining whether the number of times is equal to the expected number of times.

8. The method of claim 1, further comprising outputting a report comprising an indication of whether or not the expectation set was satisfied based at least in part on the determination.

9. The method of claim 8, wherein the report comprises information regarding at least one of: the source file name and line number where each test point was hit, timing information specifying when each test point was hit, or whether or not specified expectations were met.

10. The method of claim 1, wherein the test point data comprises information regarding a first test point hit in code running in a first process and information regarding a second test point hit in code running in a second process different from the first process.

11. The method of claim 1, wherein the test point data comprises information regarding test points which have been hit in a first processor and wherein determining whether the hit test points comprise the test points expected to be hit is performed by a second processor physically separate from a first processor.

12. A system comprising:
a processor configured to execute code to
implement an application programming interface for receiving an expectation set comprising information regarding a plurality of test points expected to be hit;
receive test point data comprising information regarding which test points which have been hit; and
determine whether the hit test points comprise the test points expected to be hit.

13. The system of claim 12, wherein the expectation set comprises information regarding a plurality of test points not expected to be hit and wherein the processor is further configured to determine whether the hit test points do not comprise the test points not expected to be hit.

14. The system of claim 12, wherein the expectation set comprises information regarding expected data associated with one or more test points, wherein the test point data comprises returned data associated with one or more test points, and wherein the processor is further configured to determine whether the returned data matches the expected data.

15. The system of claim 12, wherein the expectation set comprises information regarding one or more expected times the plurality of test points are expected to be hit, wherein the test point information comprises information regarding when the test points have been hit, and wherein the processor is further configured to determine whether the test point have been hit within the expected times.

16. The system of claim 12, wherein the expectation set comprises information regarding an expected order in which the plurality of test point are expected to be hit, wherein the test point data comprises information regarding the order in which the test points have been hit, and wherein the processor is further configured to determine whether the order in which the test points have been hit is the same as the expected order.

17. The system of claim 12, wherein the expectation set comprises information regarding a expected number of times which a particular test point is expected to be hit, wherein the test point data comprises information regarding a number of times the particular test point is hit, and wherein the processor is further configured to determine whether the number of times is greater than or equal to the expected number of times.

18. The system of claim 12, wherein the expectation set comprises information regarding a expected number of times which a particular test point is expected to be hit, wherein the test point data comprises information regarding a number of times the particular test point is hit, and wherein the processor is further configured to determine whether the number of times is equal to the expected number of times.

19. The system of claim 12, further comprising an output device configured to output a report comprising an indication of whether or not the expectation set was satisfied based at least in part on the determination.

20. The system of claim 19, wherein the report comprises information regarding at least one of: the source file name and line number where each test point was hit, timing information specifying when each test point was hit, or whether or not specified expectations were met.

21. The system of claim 12, wherein the test point data comprises information regarding a first test point hit in code running in a first process and information regarding a second test point hit in code running in a second process different from the first process.

22. The system of claim 12, wherein the test point data comprises information regarding test points which have been hit in another processor physically separate from the processor.

23. The system of claim 12, wherein the test point data is received from another processor physically separate from the processor.

24. The system of claim 23, wherein the test point data is defined on the other processor and received by the processor via a communication interface.

25. A system comprising:
means for receiving, via an application programming interface, an expectation set comprising information regarding a plurality of test points expected to be hit;
means for receiving test point data comprising information regarding which test points which have been hit; and
means for determining whether the hit test points comprise the test points expected to be hit.

26. A computer-readable medium having processor-executable instructions encoded thereon which, when executed by a processor, cause a computer to perform a method, the method comprising:
receiving, via an application programming interface, an expectation set comprising information regarding a plurality of test points expected to be hit;
receiving test point data comprising information regarding which test points which have been hit; and
determining whether the hit test points comprise the test points expected to be hit.
